(19) United States
(12) Patent Application Publication
(10) Pub. No.: US 2005/0109063 A1
(43) Pub. Date: May 26, 2005

(54) Method and apparatus for conducting a fusion process on fibers

(76) Inventor: Ljerka Ukrainczyk, Painted Post, NY (US)

Correspondence Address: CORNING INCORPORATED, SP-TI-3-1, CORNING, NY, 14831, US

(21) Appl. No.: 10/940,581

(22) Filed: Sep. 14, 2004

Related U.S. Application Data
(63) Continuation-in-part of application No. 09/832,668, filed on Apr. 11, 2001, now abandoned.

(51) Int. Cl. C03B 37/15

(52) U.S. Cl. 65/377; 65/378; 65/485; 65/424; 65/501; 65/417

(57) ABSTRACT

An apparatus for conducting a fusion process on a fiber includes a fiber chamber having coupled thereto a first fiber holder having a groove through which a fiber can be inserted into the fiber chamber and suspended therein, a filament chamber which maintains an inert and/or reducing atmosphere, a resistive filament movably supported in the filament chamber, a partition adjoining the fiber chamber and the filament chamber, the partition being provided with an orifice, a valve which selectively opens and closes the orifice, and a positioning device which moves the resistive filament between the filament chamber and the fiber chamber when the valve opens the orifice.

### CROSS-REFERENCE TO RELATED APPLICATIONS

This application is a continuation-in-part of U.S. patent application Ser. No. 09/832,668, filed Apr. 11, 2001, the disclosure of which is herein incorporated by reference.

### BACKGROUND OF INVENTION

FIG. 1 shows a micro-optic device 1 including micro-optic elements 2, such as filters, polarizers, etc., aligned with an input fiber 3 and an output fiber 4. A collimating lens 5, such as a ball lens, graded-index (GRIN) lens, asphere lens, etc., is inserted between the input fiber 3 and the micro-optic elements 2. A second collimating lens 6 is inserted between the micro-optic elements 2 and the output fiber 4. Because optical fibers are divergent in nature, light 7 transmitted through the input fiber 3 diverges rapidly upon exiting the input fiber 3. One function of the collimating lens 5 is to collimate the light 7 exiting the input fiber 3. The collimated light passes through the micro-optic elements 2 and is gathered by the collimating lens 6. The collimating lens 6 converges the light into the output fiber 4. To ensure efficient optical coupling in the system, the collimating lenses 5, 6 must be properly aligned with the input and output fibers 3, 4 in three dimensions.

Various mechanical methods for coupling lenses to optical fibers are known in the art. FIG. 2 shows an example where an optical fiber 10 is mechanically coupled to a lens 12 by an alignment device 14. A refractive-index matching agent 16 is disposed between the optical fiber 10 and lens 12 to minimize reflection of the light signal. Coupling the lens 12 to the optical fiber 10 in the manner shown in FIG. 2 requires aligning the optical axis of the optical fiber 10 and the optical axis of the lens 12 at submicron level. This process can be very time consuming. Because the lens 12 is independent of the optical fiber 10 and must be precisely aligned with the optical fiber 10, fabricating this type of fiber-optic system is expensive and may result in decreased efficiency in optical coupling. This is also true for independent lens systems that are attached to optical fibers by other means such as gluing. In the case of gluing, the materials used to bond the lens to the fiber can present reliability problems in terms of micro-movement of the lens and fiber in hostile operating conditions.

U.S. Pat. No. 5,293,438 issued to Konno et al. proposes a solution that includes integrally forming a lens with an optical fiber using a fusion process. An optical fiber with an integrally formed lens is referred to as a lensed fiber. FIG. 3 shows a lensed fiber 20 having an optical fiber 22 integrally formed with a spherical lens 26. The lensed fiber 20 is made by fusion-splicing the optical fiber 22 to a rod 24 made of a lens material, such as silica or borosilicate. The fiber-to-rod splice is shown at 25. To form the lens 26, a fusion process is used to form a radius of curvature at the end of the rod 24 not spliced to the optical fiber 22. One of the primary advantages of lensed fibers is simplified packaging because the lens is already aligned with and integrally formed with the fiber. Thus, there is no need for mechanically attaching or gluing the lens to the fiber. Also, a lensed fiber can be made in a wide range of sizes so that its spot size and working range can be tailored for a particular application. Lensed fiber consisting of planoconvex lens fusion-spliced to optical fiber has been proposed as a replacement for GRIN lens in micro-optic packages.

Fabrication of a lensed fiber generally involves four steps: (1) pre-positioning, (2) splicing, (3) taper-cutting, and (4) melting-back. Using the lensed fiber 20 in FIG. 3 as an example, the pre-positioning step involves aligning the optical fiber 22 with the rod 24 such that one end of the optical fiber 22 is in opposing relation with one of the rod 24. The splicing step involves pushing the opposing ends of the optical fiber 22 and the rod 24 together while heating them to fuse or melt the ends together. The taper-cutting step involves moving a heat source to a desired location along the rod 24 to taper the rod 24 to a desired length. The melting-back step involves moving the heat source back towards the splice 25, i.e., the joint between the optical fiber 22 and the rod 24, by a selected distance to form the lens 26. The distance the heat source is moved back towards the splice 25 depends on the desired radius of curvature for the lens 26. The closer the heat source is to the splice 25, the larger the radius of curvature of the lens 26.

Fabrication of a lensed fiber, such as the lensed fiber 20 of FIG. 3, requires a uniform heat source to allow for a formation of a substantially perfectly spherical lens 26 at the end of the fiber 22. One possible heat source is a standard fusion splicer with a tungsten filament. FIG. 4 shows a cassette 30 used in a standard fusion splicer, such as one sold under the trade name FFS-2000 by Vytran Corporation of Morganville, N.J. The cassette 30 includes a tungsten filament loop 32, which has been shown to provide exceptionally uniform heat that allows for the formation of a spherical lens with a symmetrical circular mode field. However, manufacturing lensed fibers using a standard fusion splicer, such as sold under the trade name FFS-2000 by Vytran Corporation, has not been practical because the lifetime of the filament of the fusion splicer is very short, at least in comparison to when the fusion splicer is used for fusion-splicing of fibers. The reasons for this short filament lifetime are discussed below.

Filament powers required during fabrication of a lensed fiber are generally higher than the filament power required for standard fusion-splicing of fibers. For example, using a standard filament loop on a Vytran FFS-2000 splicer with a 15 Amp DC power supply, the filament powers required to fabricate a lensed fiber from an optical fiber, such as a Corning® SMF-28™ optical fiber, and a 200 micron diameter silica rod are 21 W for splicing, 26 W for taper cutting, and 31 W for melting back. On the other hand, the filament power required for standard fusion-splicing of optical fibers, such as a Coring® SMF-28™ optical fiber to another Corning® SMF-28™ optical fiber, is 21 W. Table 1 below shows typical filament powers required for fabrication of lensed fiber depending on rod material.

TABLE 1
Filament powers required for fabrication of lensed fiber

| | Filament Power (Watts, W) | | |
|---|---|---|---|
| Process | Silica | B₂O₃—SiO₂ | GeO₂—SiO₂ |
| Splicing | 21 | 18 | 19 |
| Taper-cut | 26 | 21 | 24 |
| Melting-back | 31 | 24 | 26 |

In addition, during fabrication of a lensed fiber, the filament is on much longer than when used to make a standard fiber-to-fiber splice. For example, the filament of the fusion splicer sold under the trade name FFS-2000 by Vytran Corporation is on an average of about 25 seconds when forming a lens using the method described above and only an average of 5 seconds when forming a standard fiber-to-fiber splice. Because the filament powers for lens formation are much higher and the filament stays on much longer, the lifetime of the filament is greatly reduced when used for lens fabrication. For example, while a filament, such as the filament of the fusion splicer sold under the trade name FFS-2000 by Vytran Corporation, can typically make around 500 fiber-to-fiber splices, it is typically only capable of making a maximum of about 80 lenses when silica is used as the lens material and about 150 lenses when borosilicate glass is used as the lens material.

Another reason for a short filament lifetime using existing technology, such as the FFS-2000 fusion splicer sold by Vytran Corporation, is that the tungsten filament of the fusion splicer is exposed to air. In the current fusion processes, the filament loop, which is run with a DC current, sits inside a splice head that is completely open to air. Exposure of the tungsten filament to air results in tungsten oxidation. When the filament is used for splicing or making a lens, the filament is purged with argon at about 0.5 to 1 L/min. However, when the filament is not in use, it is exposed to air. Tungsten oxide has a much lower melting point than tungsten metal, which leads to constant evaporation of oxidized tungsten from the surface of the filament until the filament is so thin that it breaks.

Although other sources of heat, such as a CO₂ laser, may potentially be used for fabricating a lensed fiber, these sources have not been shown to provide heat that is sufficiently uniform and controlled to allow for the level of lens reproducibility necessary for production. On the other hand, filament loops, such as in fusion splicers, have been shown to achieve a select rate of 90% or better in the production of lensed fiber with a working distance of 4 mm when borosilicate glass is used as the lens material. The term “select rate” is the number of lenses that meets the specification. With a working distance of 4 mm, the size of lenses that can be made is limited. However, larger lenses can be made if the filament loop is made larger. Because filament lifetime is a major limitation on fabrication processes for lensed fiber, a new apparatus and method for increasing the lifetime of a filament is desired.

### SUMMARY OF INVENTION

In one aspect, the invention relates to an apparatus for conducting a fusion process on a fiber which includes a fiber chamber having coupled thereto a first fiber holder having a groove through which a fiber can be inserted into the fiber chamber and suspended therein, a filament chamber which maintains an inert and/or reducing atmosphere, a resistive filament movably supported in the filament chamber, a partition adjoining the fiber chamber and the filament chamber, the partition being provided with an orifice, a valve which selectively opens and closes the orifice, and a positioning device which moves the resistive filament between the filament chamber and the fiber chamber when the valve opens the orifice.

In another aspect, the invention relates to a method of conducting a fusion process on a fiber which includes providing an inert and/or reducing atmosphere in a filament chamber in which a resistive filament is movably supported, inserting a fiber into a fiber chamber, opening an orifice provided in a partition adjoining the filament chamber and the fiber chamber, extending the filament through the orifice into the fiber chamber to conduct a fusion process on the fiber, retracting the filament through the orifice into the filament chamber, and closing the orifice.

Other features and advantages of the invention will be apparent from the following description and the appended claims.

### BRIEF DESCRIPTION OF DRAWINGS

FIG. 1 is a schematic representation of a micro-optic device.

FIG. 2 is a schematic of a prior art method for coupling a lens to an optical fiber.

FIG. 3 is a schematic of a prior art lensed fiber.

FIG. 4 shows a prior art fusion splicer with a filament loop.

FIG. 5 is a front view of an apparatus for conducting a fusion process in accordance with one embodiment of the invention.

FIGS. 6A and 6B are cross-sections of the apparatus shown in FIG. 5.

FIG. 7 is a front view of an apparatus for conducting a fusion process in accordance with another embodiment of the invention.

FIG. 8 shows filament chambers mounted on a carousel.

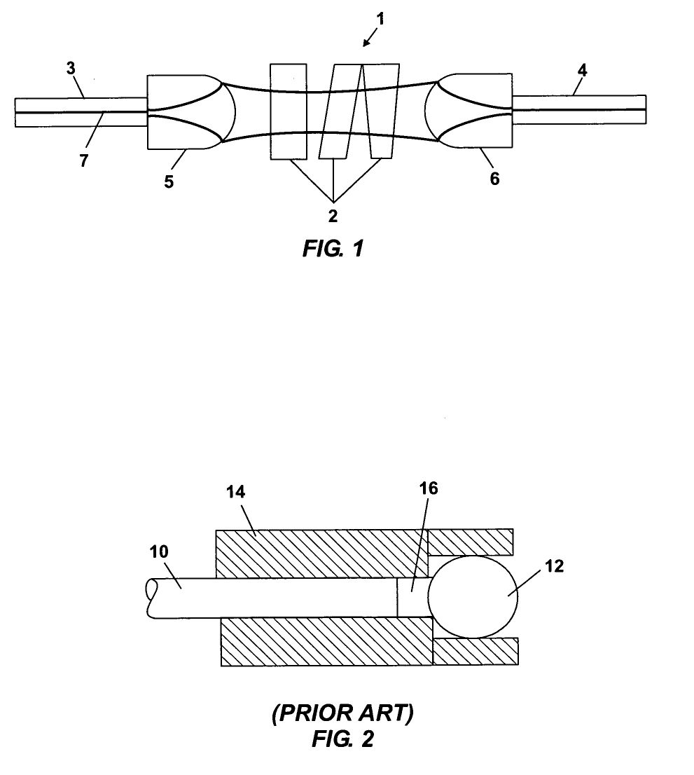

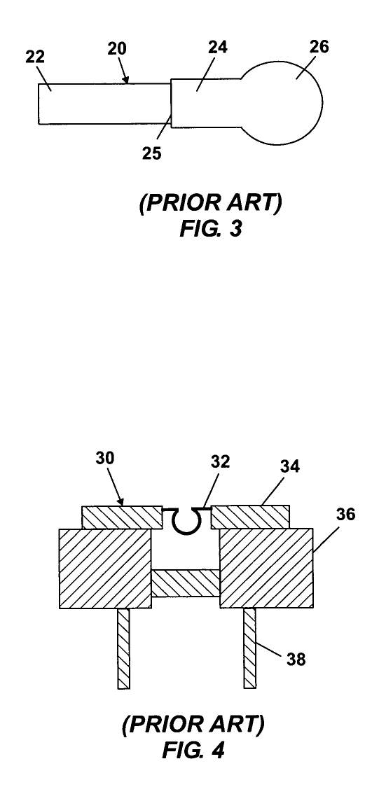

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

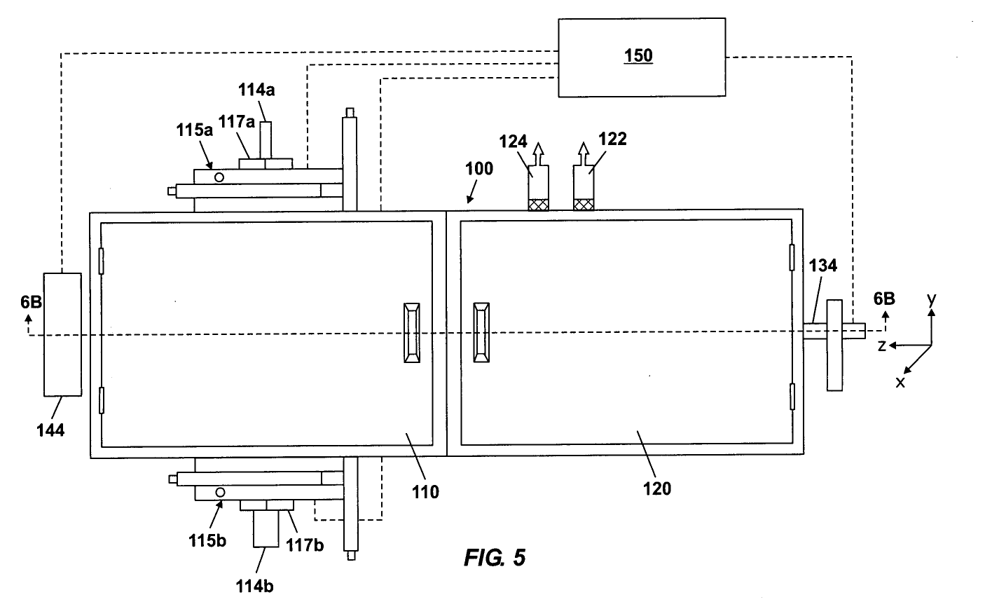

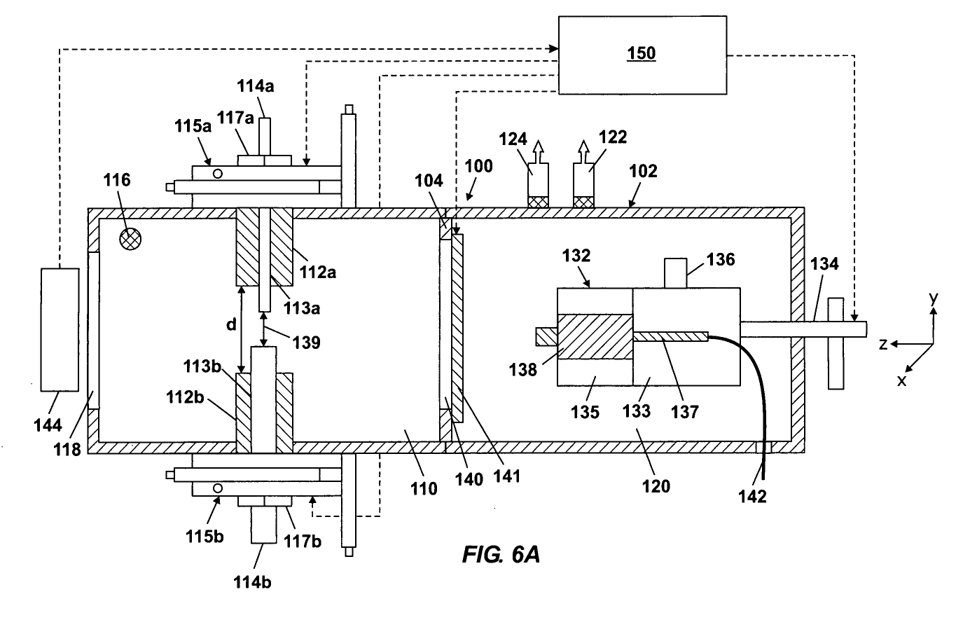

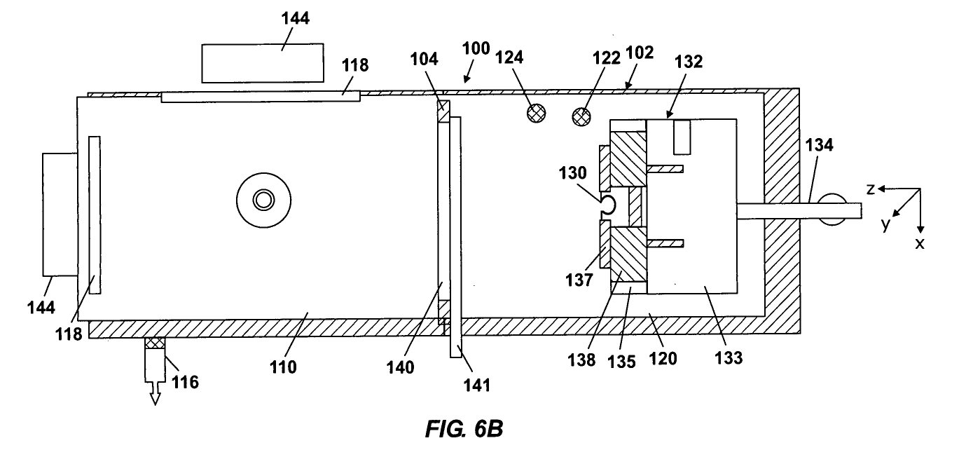

FIG. 5 shows an apparatus 100 for conducting a fusion process using a resistive filament as a heat source. The apparatus 100 typically provides advantages when the resistive filament is one made of a material that easily oxidizes, such as tungsten. The apparatus 100 may be used to fabricate a lensed fiber or splice fibers or taper a fiber. The apparatus 100 includes a fiber chamber 110 and a filament chamber 120. The chambers 110, 120 are preferably fabricated from a corrosion-resistant material such as stainless steel. The fusion process takes place inside the fiber chamber 110. In operation, fibers, such as fibers 114a, 114b, are inserted in the fiber chamber 110 so that a fusion process can be performed on them. The fibers inserted in the fiber chamber 110 may be selected from optical fibers (with waveguide cores) and glass rods (without waveguide cores). A resistive filament (130 in FIG. 6B) is stored in an inert or reducing atmosphere inside the filament chamber 120 when it is not being used to perform a fusion process on fibers in the fiber chamber 110. The resistive filament (130 in FIG. 6B) can be extended into the fiber chamber 110 as necessary to perform a fusion process on the fibers.

FIG. 6A shows a cross-section of the apparatus 100. A partition 104 adjoins the fiber chamber 110 and the filament chamber 120. The partition 104 includes an orifice 140 through which the resistive filament (130 in FIG. 6B) in the filament chamber 120 can be extended into the fiber chamber 110 and subsequently retracted into the filament chamber 120. A valve 141 is provided at the orifice 140 to selectively open and close the orifice 140. The valve 141 may be any mechanism capable of opening and closing the orifice 140. Preferably, the valve 141 forms a substantially airtight seal between the fiber chamber 110 and the filament chamber 120 when in the closed position, thereby minimizing airflow from the fiber chamber 110 into the filament chamber 120 when the filament (130 in FIG. 6B) is stored in the filament chamber 120. The valve 141 may be a sliding door or a hinged door, similar to those found in multiple-chamber glove boxes. Alternatively, the valve 141 may be a gate valve. Various types of gate valves suitable for use in the invention are available from, for example, MDC Vacuum Products Corporation, Hayward, Calif. Preferably, the valve 141 can be controlled to the open or closed position from the outside of the apparatus 100, e.g., from a control system 150.

Fiber holders (or guides) 112a, 112b are mounted in openings at the top and bottom of the fiber chamber 110. (The fiber holders may also be an integral part of the fiber chamber.) The fiber holders 112a, 112b have grooves 113a, 113b, respectively, through which fibers, e.g., fibers 114a, 114b, are inserted into the fiber chamber 110. The grooves 113a, 113b may be V-grooves. Alignment devices 115a, 115b are coupled to the fiber chamber 110. The alignment devices 115a, 115b have bores which are aligned with the grooves 113a, 113b, respectively, in the fiber holders 112a, 112b. This allows fibers 114a, 114b to be inserted through the alignment devices 115a, 115b into the grooves 113a, 113b and fiber chamber 110. The alignment devices 115a, 115b may include fiber grippers 117a, 117b, e.g., gripping jaws, at the entrance of the bores to grip the fibers 114a, 114b once a desired length of the fibers 114a, 114b have been inserted into the fiber chamber 110. Alternatively, the fiber grippers may be incorporated in the fiber holders 112a, 112b. The alignment devices 115a, 115b allow alignment of the fibers 114a, 114b inside the fiber chamber 110.

In one embodiment, the alignment devices 115a, 115b are xyz stages capable of translating the fibers 114a, 114b in three dimensions. The xyz stages may be driven manually or automatically, e.g., using motors, such as DC or stepper motors or servomotors. The xyz stages may be compound stages or may be made of individual translation stages. A stage or actuator providing translation in fewer than three dimensions may also be used as the alignment devices 115a, 115b. For example, adjusting the fibers 114a, 114b along the y-axis only may suffice if the grooves 113a, 113b are aligned with sufficient precision. The alignment devices 115a, 115b may also incorporate tilt platforms to allow for angular adjustment of the fibers 114a, 114b. The alignment devices 115a, 115b may also incorporate a rotational stage or actuator which would allow the fibers 114a, 114b to be rotated within the fiber chamber 110. Alternatively, actuators may be provided separately from the alignment devices 115a, 115b to selectively grip and rotate the fibers 114a, 114b. The actuators may be mounted above and below the alignment devices 115a, 115b, respectively. To give an idea of the working area in the fiber chamber 110, the distance (d) between the fiber holders 112a, 112b, would typically be on the order of 5 mm. Preferably, the alignment devices 115a, 115b have positional accuracy and resolution in the micron or high sub-micron range, preferably 10-25 nm range.

In one embodiment, the fiber chamber 110 includes one or more viewing ports 118, such as fused silica windows. A viewing device 144, such as camera, may be mounted at the viewing port 118 to capture images of the fibers 114a, 114b in the fiber chamber 110. For example, when the fibers 114a, 114b are being aligned using the alignment devices 115a, 115b, the image of the fibers 114a, 114b inside the fiber chamber 110 may be captured through the viewing port 118 by the viewing device 144. This image may then be supplied to the control system 150, which will use the supplied data to control operation of the alignment devices 115a, 115b. The viewing device 144 may also be used to capture the image of a lens while forming the lens from a fiber inserted in the fiber chamber 110. The captured lens image can be sent to the control system 150, which may include an algorithm for measuring the dimension of the lens from the lens image. As will be further discussed below, the measured dimensions of the lens can be used to control positioning of the filament (130 in FIG. 6B) with respect to the fibers 114a, 114b during manufacture of the lensed fiber.

FIGS. 6A and 6B show a filament support structure 132 disposed in the filament chamber 120. The filament support structure 132 comprises a head 133 which holds a filament cassette 135. The filament cassette 135 comprises an insulating plate 138 and electrodes 137 that extend through the insulating plate 138. One end of the electrodes 137 is coupled to a power supply (not shown) through, for example, leads (142 in FIG. 6A). The other end of the electrodes 137 is coupled to the filament (130 in FIG. 6B). The electrodes 137 support and provide power to the filament 130. In one embodiment, the filament 130 is made of tungsten. In one embodiment, the filament 130 is a loop or is generally circular so that it uniformly distributes heat about the diameters of the fibers 114a, 114b during a fusion process. The filament support structure 132 is movable between the filament chamber 120 and the fiber chamber 110 through the orifice 140. In one embodiment, a positioning device 134, such as an xyz stage or yz stage or a linear translation stage or actuator, is coupled to the filament support structure 132 to move the filament support structure 132 such that the filament 130 is positioned in the fiber chamber 110 and to provide controllable alignment of the filament 130 with the fibers in the fiber chamber 110.

The positioning device 134 may be operated manually or may be automated, e.g., driven by one or more motors. The positioning device 134 may receive control signals from the control system 150, where the control system may generate control signals in response to images captured through the viewing ports 118 in the fiber chamber 110. Preferably, the positioning device 134 has positional accuracy and resolution in the micron or high sub-micron range, preferably 10-25 nm range. In one embodiment, an optical sensor 136 is coupled to the filament support structure 132 to detect (or measure) a gap (139 in FIG. 6A) between the fibers 114a, 114b to ensure, for example, that the filament 130 is centered at the gap (139 in FIG. 6A) prior to fusion-splicing of the fibers 114a, 114b.

In operation, the filament chamber 120 maintains an inert or reducing atmosphere so that oxidation of the resistive filament 130 is reduced. Thus, storing the resistive filament 130 in the filament chamber 120 when not in use can prolong the lifetime of the resistive filament 130. The inert or reducing atmosphere may be achieved as follows: once the filament support structure 132 (with the filament) is disposed in the filament chamber 120, a vacuum pump (not shown) may be coupled to a port 122 in the filament chamber 120 to evacuate or pump down the filament chamber 120. A gas source (not shown) may then be coupled to a port 124 in the filament chamber 120 to supply an inert gas, such as argon, or a mixture of inert gas and reducing agent, such as argon with several percent of hydrogen, into the filament chamber 120. Baffles 126 may be provided at the ports 122, 124 to impede flow of gas into and out of the filament chamber 120. Mass flow controls (not shown) may be provided as necessary to control flow of gas into and out of the filament chamber 120. The orifice 140 is preferably closed while providing the inert or reducing atmosphere in the filament chamber 120.

Preferably, the fiber chamber 110 also maintains an inert atmosphere, at least around the filament 130, when the filament 130 is being used for a fusion process in the fiber chamber 110. To achieve this, the fiber chamber 110 may be filled with an inert gas, such as argon, or an inert gas with a reducing agent, such as argon with several percent hydrogen. The fiber chamber 110 may include a port 116 that may be coupled to an inert gas source. The fiber chamber 110 may also include a separate port (not shown) that may be coupled to a vacuum pump (not shown). The vacuum pump may be used to evacuate or pump down the fiber chamber 110 prior to pumping the inert gas into the fiber chamber 110. The fiber chamber 110 is always leaky because of the need to continually load fibers into the fiber chamber 110 and remove fiber and lenses from the fiber chamber 110. To minimize air flow into the fiber chamber 110, the fiber chamber 110 is preferably maintained at a positive pressure by supplying the inert gas to the fiber chamber 110 at a higher pressure than ambient pressure.

When the apparatus 100 is used for fabricating a lensed fiber, one of the fibers 114a, 114b is an optical fiber and the other of the fibers is a glass rod made of a lens material such as silica or borosilicate. For example, the fiber 114a could be the optical fiber and the fiber 114b could be the glass rod made of a lens material. As can be seen in the drawing, the fiber 114b has a larger diameter than the fiber 114a; however, this is not a requirement. The fiber 114b may have the same diameter as the fiber 114a or a smaller diameter than the fiber 114a. Referring to FIG. 6A, to begin fabrication of the lensed fiber, the fibers 114a, 114b are inserted into the fiber chamber 110 and aligned using the alignment devices 115a, 115b. At this time, the orifice 140 in the partition 104 between the filament chamber 120 and the fiber chamber 110 is closed so that the fibers 114a, 114b can be inserted into the fiber chamber 110 without exposing the filament (130 in FIG. 6B) to air. As the fibers 114a, 114b are inserted into and aligned within the fiber chamber 110 (or after aligning the fibers inside the fiber chamber), the fiber chamber 110 is purged with an inert gas (or an inert gas mixed with a reducing gas), which may be supplied through the port 116. The valve 141 is then operated to open the orifice 140, permitting the filament support structure 132 to move into the fiber chamber 110. To prolong the lifetime of the filament, the fiber chamber 110 is preferably always purged with an inert gas prior to opening the orifice 140 and extending the filament support structure 132 (with the filament) into the fiber chamber 110.

When the filament (130 in FIG. 6B) is in the fiber chamber 110, power is supplied to the filament (130 in FIG. 6B) to form the lensed fiber. To form the lensed fiber, the fiber 114a and lens material rod 114b are spliced by pushing their opposing ends together while being heated by the filament (130 in FIG. 6B). After splicing, the filament (130 in FIG. 6B) is moved by a desired distance along the lens material rod 114b to taper (or cut) the lens material rod 114b to a desired length. After tapering the lens material rod 114b, the filament (130 in FIG. 6B) is moved towards the splice, i.e., the joint formed between the fiber 114a and the lens material rod 114b, by a distance that depends on the desired radius of curvature of the lens to be formed on the lens material rod 114b. In general, the closer the filament (130 in FIG. 6B) is to the splice, the smaller the radius of curvature of the lens formed. After the lensed fiber is formed, the filament support structure 132 is retracted back into the filament chamber 120, and the orifice 140 is closed to preserve the inert atmosphere in the filament chamber 120. The lensed fiber is then removed from the fiber chamber 110, and the process is repeated again for fabrication of other lensed fibers.

The viewing device 144 may also be used to capture the image of the lens while forming the lens to measure the dimensions of the lens after forming the lens. In general, it has been determined that the filament (130 in FIG. 6B) makes lenses with very reproducible radius of curvature when borosilicate glass is used. However, the length of the lens may need to be adjusted periodically using an algorithm that calculates the desired length and determines the position the filament (130 in FIG. 6B) should move to during the taper cut to make the correct length. The algorithm may be used to control the positioning device 134 coupled to the filament support structure 132.

In one embodiment, the position the filament (130 in FIG. 6B) should move to during a taper-cut step is adjusted based on measurement of thickness of the previous lens. In this embodiment, the adjustment is done so that the ratio of the thickness of the lens to the radius of curvature of the lens is substantially constant, as shown by the following equation:

$${T}_{new} = {T}_{old} + \frac{( \frac{{T}_{measured}}{{R}_{measured}} - \frac{{T}_{target}}{{R}_{target}} ) \cdot {R}_{measured}}{F} \qquad ( 1 )$$

where T_{new} is the adjusted number of taper cut steps for the next lens to be made, T_{old} is the number of taper cut steps used in making the previous lens, T_{measured} is the measured thickness of the lens, R_{measured} is the measured radius of curvature of the lens, T_{target} is the target thickness of the lens, R_{target} is the target radius of curvature of the lens, and F is the dampened step size of the splice head 133 moving along the fiber-optic axis. Dampening is determined experimentally to achieve a stable process. Typically, the ratio T_{target}/R_{target} is about 3.5. Equation (1) above may be used to control the positioning device 134 coupled to the filament support structure 132.

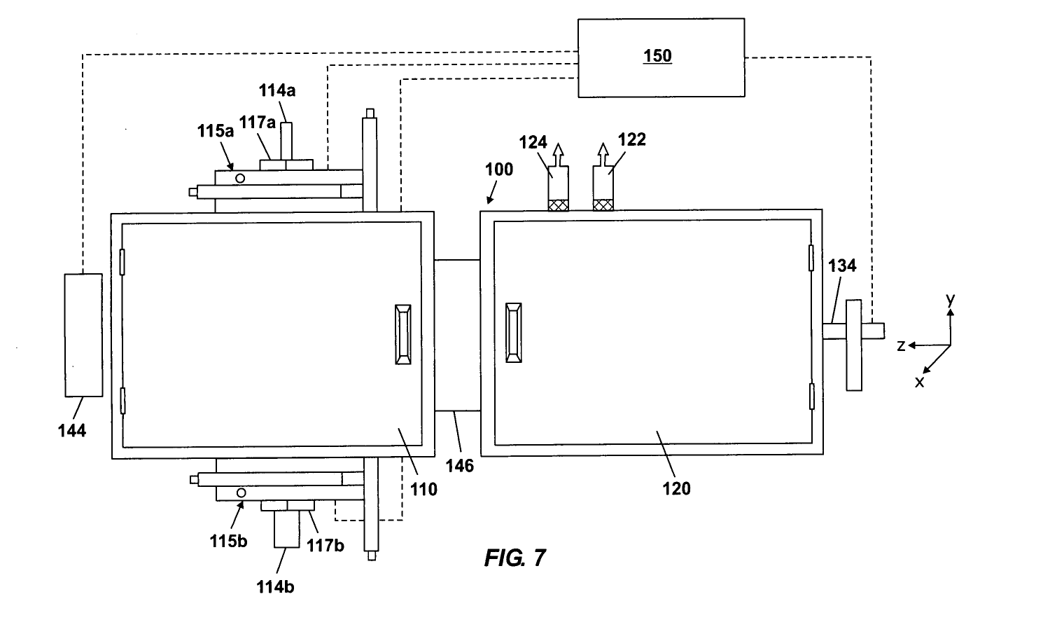

Those skilled in the art will appreciate that various modifications can be made to the apparatus 100 shown in FIGS. 5, 6A, and 6B that are within the scope of the invention. For example, as shown in FIG. 7, the fiber chamber 110 and filament chamber 120 may be structurally independent chambers, i.e., not placed immediately adjacent to each other. The filament chamber 120 and fiber chamber 110 may be connected to a passage 146. One end of the passage 146 would communicate with the fiber chamber 110 through an aperture (not shown) in the fiber chamber 110, and the other end of the passage 146 would communicate with the filament chamber 112 through an aperture (not shown) in the filament chamber 112. The filament support structure (132 in FIG. 6B) could then pass through the passage 146 into the fiber chamber 110. One or both of the chambers 110, 120 may include a door (not shown) or gate valve adapted to selectively block the corresponding aperture (not shown) so that the filament chamber 120 can be selectively isolated from the fiber chamber 110, such as during loading and unloading of fibers 114a, 114b in the fiber chamber 110. Alternatively, a door, valve, or other closable device may be disposed in the passage 146.

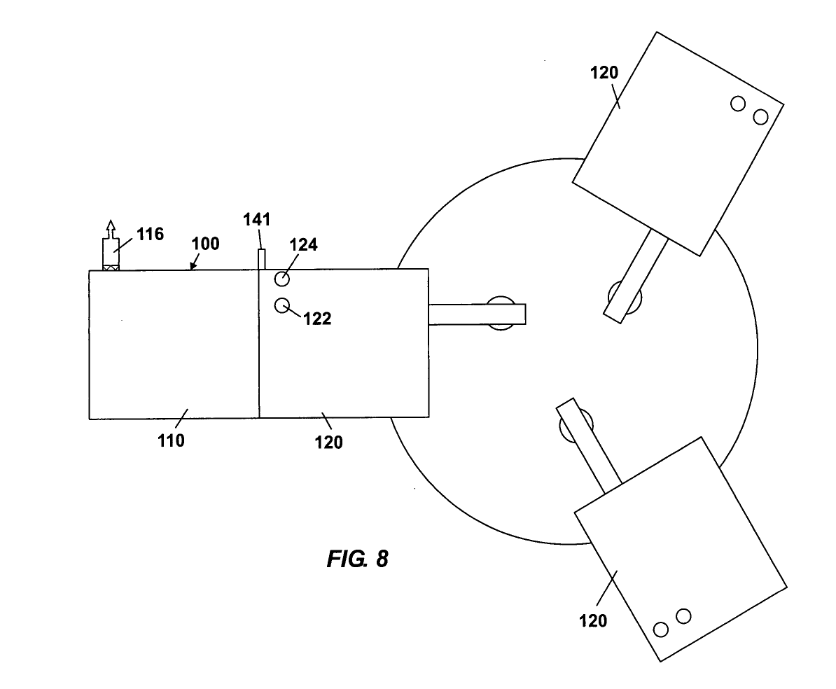

In another embodiment, to facilitate removal of the filament (130 in FIG. 6B) when burnt out, the filament support structure (132 in FIG. 6B) and positioning device (134 in FIG. 6B) can be attached to a flange (not shown). The flange (not shown) may then be mounted on the filament chamber (120 in FIG. 6B). When it is desired to change the filament, the flange can be quickly removed from the filament chamber and replaced with another flange that already has a filament support structure and a new filament and a positioning device attached to it. Alternatively, as shown in FIG. 8, multiple filament chambers 120 may be loaded on a turntable or carousel 148, or the like. Any one of the filament chambers 120 may be connected to the fiber chamber 110 at any given time while any burnt-out filaments are replaced in the other filament chambers 120.

The invention typically provides the following advantages. Storing the filament in an inert and/or reducing atmosphere when not in use prolongs the lifetime of the filament. The lifetime of the filament is further prolonged by purging the fiber chamber with an inert and/or reducing gas prior to extending the filament into the fiber chamber for a fusion process. The apparatus allows automation of the lens fabrication process. The configuration of the apparatus can be adjusted as necessary to allow for fabrication of larger lenses.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An apparatus for conducting a fusion process on a fiber, comprising:
a fiber chamber having coupled thereto a first fiber holder having a groove through which a fiber can be inserted into the fiber chamber and suspended therein;
a filament chamber which maintains an inert and/or reducing atmosphere;
a resistive filament movably supported in the filament chamber;
a partition adjoining the fiber chamber and the filament chamber, the partition being provided with an orifice;
a valve which selectively opens and closes the orifice; and
a positioning device which moves the resistive filament between the filament chamber and the fiber chamber when the valve opens the orifice.

2. The apparatus of claim 1, wherein the fiber chamber includes a port through which the fiber chamber may be purged with an inert gas and/or a reducing gas.

3. The apparatus of claim 1, wherein the fiber chamber includes one or more viewing ports.

4. The apparatus of claim 1, further comprising an alignment device for adjusting a position of the fiber in the fiber chamber.

5. The apparatus of claim 4, further comprising a second fiber holder coupled to the fiber chamber in opposing relation to the first fiber holder, the second fiber holder having a groove through which a fiber can be inserted into the fiber chamber and suspended therein.

6. The apparatus of claim 5, wherein an optical sensor is coupled to the resistive filament for detecting a gap between fibers inserted through the fiber holders.

7. The apparatus of claim 1, wherein the resistive filament has a generally circular shape which uniformly distributes heat about a diameter of the fiber.

8. A method of conducting a fusion process on fibers, comprising:
providing an inert and/or reducing atmosphere in a filament chamber in which a resistive filament is movably supported;
inserting a fiber into a fiber chamber;
opening an orifice provided in a partition adjoining the filament chamber and the fiber chamber;
extending the filament through the orifice into the fiber chamber to conduct a fusion process on the fiber;
retracting the filament through the orifice into the filament chamber; and
closing the orifice.

9. The method of claim 8, wherein prior to opening the orifice, the fiber chamber is purged with an inert gas and/or a reducing gas.

10. The method of claim 9, wherein the fiber chamber is maintained at a higher pressure than ambient pressure.
